(19) United States
(12) Patent Application Publication
(10) Pub. No.: US 2021/0031464 A1
(43) Pub. Date: Feb. 4, 2021

(54) METHOD FOR MANUFACTURING A BODY MADE OF A POROUS MATERIAL

(71) Applicant: BASF SE, Ludwigshafen am Rhein (DE)

(72) Inventors: Dirk WEINRICH, Lemfoerde (DE); Marc FRICKE, Lemfoerde (DE); Volker VOGELSANG, Lemfoerde (DE); Wibke LOELSBERG, Ludwigshafen (DE); Christian STELLING, Lemfoerde (DE); Marcel NOBIS, Lemfoerde (DE); Torben KAMINSKY, Lemfoerde (DE); Maria THOMAS, Lemfoerde (DE)

(73) Assignee: BASF SE, Ludwigshafen am Rhein (DE)

(21) Appl. No.: 16/969,066

(22) PCT Filed: Feb. 28, 2019
(86) PCT No.: PCT/EP2019/055012

§ 371 Date: Aug. 11, 2020

(30) Foreign Application Priority Data
Mar. 1, 2018 (EP) 18159506.7

(51) Int. Cl. B29C 67/20; C08J 9/28; C08G 18/76; C08G 18/32; C08G 18/20; C08G 18/18; C08G 18/09

(52) U.S. Cl. CPC B29C 67/202; C08J 9/286; C08G 18/7671; C08G 18/7621; C08G 18/3243; B29K 2075/00; C08G 18/2036; C08G 18/2027; C08G 18/1833; C08G 18/1816; C08G 18/092; C08G 18/2063

(57) ABSTRACT

A method for manufacturing a body made of a porous material derived from precursors of the porous material in a sol-gel process, including (i) providing a mold, containing a lower part defining an interior volume for receiving the precursors of the porous material, wherein the lower part comprises a first opening, and surfaces of the lower part facing the interior volume are at least partially provided with a coating made of a material being electrically dissipative and non-sticky to the precursors of the porous material and/or the body, (ii) filling precursors of the porous material into the lower part in a first inert or ventilated region, wherein the precursors include two reactive components and a solvent, (iii) removing the body from the lower part through the first opening after a predetermined time, (iv) disposing the body onto a support, and (v) removing the solvent from the body.

### TECHNICAL FIELD

The present invention relates to a method for manufacturing a body made of a porous material derived from precursors of the porous material in a sol-gel process.

### BACKGROUND

Porous materials, for example polymer foams, having pores in the size range of a few microns or significantly below and a high porosity of at least 70% are particularly good thermal insulators on the basis of theoretical considerations.

Such porous materials having a small average pore diameter can be, for example, in the form of organic aerogels or xerogels which are produced with a sol-gel process and subsequent drying. In the sol-gel process, a sol based on a reactive organic gel precursor is first produced and the sol is then gelled by means of a crosslinking reaction to form a gel. To obtain a porous material, for example an aerogel, from the gel, the liquid has to be removed. This step will hereinafter be referred to as drying in the interests of simplicity. For example, in case of an aerogel, pores can collapse requiring typically special drying processes such as supercritical drying with carbon dioxide.

Particularly, during the process for preparing a porous material, a mixture is provided that comprises the reactive precursors and a solvent. In order to define the shape of the porous material, a mold into which this mixture is filled may be basically used. After gelling and drying, the thus formed body made of a porous material has to be removed from the mold.

### SUMMARY

A particular problem associated with the use of molds is that the solvent vapor is hazardous and provides an explosion risk such that an open handling is complicate. Particularly, typical organic solvents for sol-gel processes are flammable and may also provide health hazard as well as environmental hazard. Further, an excessive loss of solvent causes shrinking of the gel, particularly for aerogels, and an irreversible damage thereof. During the removal of the solvent, a diffusion of the solvent into the surrounding atmosphere is preferred on all sides of the gel in order to accelerate the drying as otherwise the gel is not sufficiently dried and could be damaged when residual solvent evaporates after insufficient drying and leads to pore collapse.

It was therefore an object of the invention to avoid the abovementioned disadvantages. In particular, a method for manufacturing a body made of a porous material should be provided that allows to prevent a premature evaporation of the solvent from the gel. Generally, it is desired to give a porous material based on a sol-gel process a shape. This can be achieved with a mold. However, several opposing factors have to be taken into account. The mold needs to be closed to prevent premature solvent loss which can lead to explosion hazard, health hazard or quality problems due to premature solvent evaporation and resulting pore damage. This can be basically solved with a cover part or with other solutions. However, the gel needs to be dried well from all sides, which increases the accessible surface area, to reduce the drying time and possibly gel damage. For this reason, the mold needs to be more open but then the sol will leak or needs to be converted to be more open after the sol-gel process or the gel needs to be removed from the mold. The cover part can be omitted if a) the solvent vapor is contained in a closed volume or captured so as to prevent explosion and/or health hazards such as by means of an inert atmosphere against explosion hazard, b) the evaporation of solvent from the gel is minimized so far that the gel can reach and complete the subsequent drying step without pore damage due to premature solvent loss. For this reason, in practice, an enclosed inert volume makes sense to prevent explosion and health hazards since solvent vapor is kept inside. However, evaporation from the gel is only minimized if the inert volume is small such that saturation of the surrounding atmosphere with solvent vapor is achieved with solvent amounts from the gel that are small enough to prevent pore damage, wherein the level of tolerance depends on the gel, or if the inert volume is pre-saturated or partially pre-saturated with solvent vapor. For this, a ventilated volume could also be used to capture solvent vapor to prevent explosion or health hazards. But then the evaporation from the gel is faster and hence more difficult to minimize increasing the likelihood of pore damage. Residence time in the ventilated volume would need to be as small as possible. Also, the temperature could be reduced since this also leads to reduced solvent evaporation, but this is technically more challenging and more expensive.

According to the Present Invention, this Object is Solved by a Method for Manufacturing a Body Made of a Porous Material Derived from Precursors of the Porous Material in a Sol-Gel Process, Comprising

(i) providing a mold, wherein the mold comprises
a lower part defining an interior volume for receiving the precursors of the porous material, wherein the interior volume defines the shape of the body to be manufactured, at least a first opening through which the body is removable from the lower part,
wherein surfaces of the lower part facing the interior volume are at least partially provided with a coating made of a material being electrically dissipative and non-sticky to the precursors of the porous material and/or the body,
(ii) filling precursors of the porous material into the lower part in a first inert or ventilated region, wherein the precursors include two reactive components and a solvent,
(iii) removing the body from the lower part through the first opening after a predetermined time in which the body is formed from the precursors of the porous material,
(iv) disposing the body onto a support, and
(v) removing the solvent from the body.

According to the method of the present invention, it was surprisingly found that due to the filling of the precursors of the porous material into the lower part in a first inert or ventilated region, health hazard may be prevented. Further, in case the first region is an inert region, a premature evaporation of the solvent may be prevented. Particularly, the provision of the first inert or ventilated region prevents the formation of a hazardous atmosphere and an explosion risk. More particularly, regarding filling of the precursors into the mold in a ventilated area, the ventilation prevents explosion risk if a sufficient ventilation rate is applied. A premature solvent evaporation is prevented in ventilated region if a mold is used that is closed as much as possible or if the resulting gel in an open mold passes quickly through it. Regarding filling of the precursors into the mold in an inert area, a premature solvent evaporation is prevented in the inert region if a gas-tight mold is closed or if an open mold in an inert region which is already saturated with solvent vapor is used or if an open mold in an inert region which is small enough to become saturated with solvent vapor from entering gels without negative impact on quality due to pore collapse is used.

The porous materials of the present invention are preferably aerogels or xerogels.

The coating preferably comprises at least one halogen containing polymer and at least one inorganic filler. More preferably, the halogen containing polymer is a fluorinated polymer such as for example polytetrafluoroethylene, a perfluoro alkoxy polymer or a fluorinated ethylene propylene polymer.

The coating preferably comprises at least one inorganic filler and at least one polymer selected from the group consisting of polytetrafluoroethylene, perfluoro alkoxy polymers and fluorinated ethylene propylene polymers. Particularly preferred are fluorinated ethylene propylene polymers such as perfluoro ethylene propylene.

Preferred embodiments may be found in the claims and the description. Combinations of preferred embodiments do not go outside the scope of the present invention. Preferred embodiments of the components used are described below.

According to the present invention, the lower part defines an interior volume which in turn defines the shape of the porous material to be manufactured. The shape of the porous material may be any shape. Thus, the shape may be arbitrarily defined which allows to manufacture porous material with a broad range of possible shapes. Preferably, the shape is cuboid. As surfaces of the lower part facing the interior volume are at least partially provided with a coating made of a material being electrically dissipative and non-sticky to the precursors of the porous material and the body, areas of the lower part intended to contact the precursors are prevented from sticking to the precursors, the porous material and/or any intermediate product thereof. Thus, the body made of a porous material may be reliably and completely removed from the mold through the first opening. Further, as the coating is made of an electrically dissipative material, the mold is allowed to be used in explosion protection environments as an explosion due to electrostatic charge of the mold, sol and/or gel are prevented.

According to a further development of the present invention, the mold further comprises a cover part configured to close the first opening, a second opening, and a lid configured to close the second opening, wherein the method further comprises closing the first opening by means of the cover part, filling precursors of the porous material into the lower part through the second opening, and closing the second opening by means of the lid. Thus, the mold may be completely closed after the precursors have been filled into the lower part which allows to further handle the filled mold outside an inert or ventilated region.

According to a further development of the present invention, the method further comprises closing the first opening and/or the second opening in a gas tight manner. Thus, a premature evaporation may be prevented such that the exposition of hazardous components and explosion risk is prevented. Further, a negative impact on the quality of the resulting gel due to premature solvent evaporation and/or pore collapse is prevented.

According to a further development of the present invention, the method further comprises removing the cover part from the lower part in a second inert or ventilated region after a predetermined time in which the body is formed from the precursors of the porous material. Thus, the body may be removed from the lower part through the first opening. Particularly, the provision of the second inert or ventilated region prevents the formation of a hazardous atmosphere and an explosion risk. Regarding demolding in a ventilated area, a premature solvent evaporation can be prevented in the ventilated region if the gel passes quickly through it. However, it has to be noted that an open evaporation of solvent leads to unnecessary solvent loss and an excessive evaporation of solvent could lead to negative impact on the quality of the gel due to pore collapse.

According to a further development of the present invention, removing the body from the lower part and disposing the body onto the support includes disposing the support onto the lower part and turning the lower part together with the support. Thus, the body may be removed from the lower part with a simple turning movement. After turning, the body is removed preferably in a direction of gravity such that any further constructional members for the removing step may be omitted.

According to a further development of the present invention, the method further comprises fixing the support onto the lower part. Thus, an unwanted or premature disassembling of the support from the lower part is prevented.

According to a further development of the present invention, the method further comprises mixing the precursors before being filled into the lower part. Thus, the filling process for the precursors is simplified.

According to a further development of the present invention, the support comprises openings. Thus, a diffusion of the solvent into the surrounding atmosphere on all sides of the gel is ensured which makes drying faster due to more accessible surface area and possibly prevents damage to the gel/aerogel/xerogel/kryogel which might result if inhomogeneous drying occurs.

According to a further development of the present invention, the method further comprises buffering the body in the second inert or ventilated region before the body is removed from the lower part.

According to a further development of the present invention, the method further comprises buffering the body in a third inert region before removing the solvent from the body. Thus, the body may be temporarily buffered and further processed at a suitable point of time.

According to a further development of the present invention, the method further comprises buffering a plurality of bodies in a third inert region and subsequently simultaneously removing the solvent from the plurality of bodies. Thus, the efficiency of the method may be increased by removing the solvent from more than one body at the same time.

According to a further development of the present invention, the method further comprises repeating steps (i) to (iv) a predetermined number of times in a subsequent order so as to provide the plurality of bodies. Thus, the method may provide bodies in a large scale.

According to a further development of the present invention, a volume of the third inert region is adapted to a total volume of the plurality of bodies and/or the third inert region is filled or pre-saturated with vapor of the solvent such that a substantial shrinking of the gel is prevented. An adaption of a volume of the third inert region to the total volume of the plurality of bodies means that the volume is only slightly larger than the total volume such that the volume is saturated rather fast with solvent vapor so that further and possibly excessive premature evaporation and thus damage to the body is prevented. The same effect may be realized if the third inert region is already saturated with the solvent as a saturation of the atmosphere in the third inert region with the solvent is realized rather fast.

According to a further development of the present invention, the method further comprises sealing the third inert region in a gas tight manner. Thus, a leakage of solvent vapor from the third inert region to the surrounding atmosphere is prevented which in turn prevents explosion hazard, health hazard and environmental hazard.

According to a further development of the present invention, the first inert or ventilated region and/or the second inert or ventilated region are defined by a chamber. Thus, well defined spaces may be used for handling of the educts, products and intermediate products of the method such that the risk of leakage of hazardous or explosion risk components is decreased.

According to a further development of the present invention, the first region is a ventilated region and/or the second region is a ventilated region, wherein the chamber comprises an airlock. Thus, leakage of any hazardous or explosion risk components is minimized.

According to a further development, the third inert region is defined by a chamber. Thus, well defined spaces may be used for handling of the educts, products and intermediate products of the method such that the risk of leakage of hazardous or explosion risk components is decreased.

According to a further development, the third inert region is defined by a chamber comprising an airlock. Thus, leakage of any hazardous or explosion risk components is minimized.

According to a further development of the present invention, removing the solvent from the body is performed by means of an autoclave or oven. Thus, the solvent may be removed with well established constructional members, which may even allow to recycle the solvent.

According to a further development of the present invention, the method further comprises reusing the coating for at least 50 cycles of the sol gel process. Thus, the mold may be used in an economic manner.

According to a further development of the present invention, a body made of porous material, which is obtained or obtainable by the method as described above is disclosed. The bodies made of the porous materials which can be obtained according to the invention have a low thermal conductivity, a high porosity and a low density combined with high mechanical stability. In addition, the porous materials have a small average pore size. The combination of the abovementioned properties allows the materials to be used as insulation material in the field of thermal insulation, in particular for applications in the ventilated state as building materials.

According to a further development of the present invention, the use of a body made of a porous material as described before or a porous material obtained or obtainable by the process as described above as thermal insulation material or for vacuum insulation panels is disclosed. The bodies made of porous materials which can be obtained according to the invention have advantageous thermal properties and also further advantageous properties such as simple processability and high mechanical stability, for example low brittleness.

According to a further development of the present invention, the body made of a porous material is used in interior or exterior thermal insulation systems. The porous materials which can be obtained according to the invention have advantageous thermal properties and also further advantageous properties such as simple processability and high mechanical stability, for example low brittleness.

Organic and inorganic aerogels and xerogels as well as processes for their preparation are known from the state of the art. In the sol-gel process, a sol based on a reactive gel precursor is first produced and the sol is then gelled by means of a crosslinking reaction to form a gel. To obtain a porous material, for example an aerogel, from the gel, the liquid has to be removed. This step will hereinafter be referred to as drying in the interests of simplicity.

It is generally known that gel monoliths or particles based on organic (e.g. PU) or inorganic (e.g. silica) precursors can be dried, preferably via supercritical extraction (i.e. using a medium in the supercritical state, e.g. CO2) to obtain organic, inorganic or hybrid aerogels.

The chemical nature of the gel can vary. It is possible that an organic gel is provided but also inorganic gels can be subjected to the process according to the present invention. Suitable methods to prepare organic or inorganic gels are known to the person skilled in the art. Preferably, the gel is an organic gel according to the present invention.

In principle, the process does not depend on the gel chemistry. Thus, according to the present invention, any organic or inorganic gel can be used in the process, for example organic gels, such as gels based on synthetic polymers or biopolymers, or inorganic gels.

Therefore, according to a further embodiment, the present invention is also directed to the process as disclosed above, wherein the gel is an organic gel.

Organic xerogels and aerogels preferred for the purposes of the present invention are described below.

It is preferable that the organic aerogel or xerogel is based on isocyanates and optionally on other components that are reactive toward isocyanates. By way of example, the organic aerogels or xerogels can be based on isocyanates and on OH-functional and/or NH-functional compounds.

Preference is given in the invention by way of example to organic xerogels based on polyurethane, polyisocyanurate, or polyurea, or organic aerogels based on polyurethane, polyisocyanurate, or polyurea.

Accordingly, one preferred embodiment of the present invention provides a composite element comprising a profile and an insulating core enclosed at least to some extent by the profile, as described above, where the organic porous material is one selected from the group of organic xerogels based on polyurethane, polyisocyanurate, or polyurea, organic aerogels based on polyurethane, polyisocyanurate, or polyurea, and combinations of two or more thereof.

It is particularly preferable that the organic aerogel or xerogel is based on isocyanates and on components reactive toward isocyanates, where at least one polyfunctional aromatic amine is used as component reactive toward isocyanates. It is preferable that the organic xerogel or aerogel is based on polyurea and/or polyisocyanurate.

“Based on polyurea” means that at least 50 mol %, preferably at least 70 mol %, in particular at least 90 mol %, of the linkages of the monomer units in the organic xerogel or aerogel take the form of urethane linkages. “Based on polyurea” means that at least 50 mol %, preferably at least 70 mol %, in particular at least 90 mol %, of the linkages of the monomer units in the organic xerogel or aerogel take the form of urea linkages. “Based on polyisocyanurate” means that at least 50 mol %, preferably at least 70 mol %, in particular at least 90 mol %, of the linkages of the monomer units in the organic xerogel or aerogel take the form of isocyanurate linkages. “Based on polyurea and/or polyisocyanurate” means that at least 50 mol %, preferably at least 70 mol %, in particular at least 90 mol %, of the linkages of the monomer units in the organic xerogel or aerogel take the form of urea linkages and/or isocyanurate linkages.

The composite elements of the invention here can also comprise combinations of various aerogels and xerogels. It is also possible for the purposes of the present invention that the composite element comprises a plurality of insulating cores. It is also possible for the purposes of the invention that the composite element comprises, alongside the organic porous material, another insulation material, for example a polyurethane.

The term organic porous material is used below to refer to the organic aerogel or xerogel used in the invention.

It is preferable that the organic porous material used is obtained in a process which comprises the following steps:

(a) reaction of at least one polyfunctional isocyanate (a1) and of at least one polyfunctional aromatic amine (a2) in a solvent optionally in the presence of water as component (a3) and optionally in the presence of at least one catalyst (a4);
(b) removal of the solvent to give the aerogel or xerogel.

Components (a1) to (a4) preferably used for the purposes of step (a), and the quantitative proportions, are explained below.

The term component (a1) is used below for all of the polyfunctional isocyanates (a1). Correspondingly, the term component (a2) is used below for all of the polyfunctional aromatic amines (a2). It is obvious to a person skilled in the art that the monomer components mentioned are present in reacted form in the organic porous material.

For the purposes of the present invention, the functionality of a compound means the number of reactive groups per molecule. In the case of monomer component (a1), the functionality is the number of isocyanate groups per molecule. In the case of the amino groups of monomer component (a2), the functionality is the number of reactive amino groups per molecule. A polyfunctional compound here has a functionality of at least 2.

If mixtures of compounds with different functionality are used as component (a1) or (a2), the functionality of the component is in each case obtained from the number average of the functionality of the individual compounds. A polyfunctional compound comprises at least two of the abovementioned functional groups per molecule.

### Component (a1)

It is preferable to use, as component (a1), at least one polyfunctional isocyanate.

For the purposes of the process of the invention, the amount used of component (a1) is preferably at least 20% by weight, in particular at least 30% by weight, particularly preferably at least 40% by weight, very particularly preferably at least 55% by weight, in particular at least 68% by weight, based in each case on the total weight of components (a1), (a2), and, where relevant, (a3), which is 100% by weight. For the purposes of the process of the invention, the amount used of component (a1) is moreover preferably at most 99.8% by weight, in particular at most 99.3% by weight, particularly preferably at most 97.5% by weight, based in each case on the total weight of components (a1), (a2), and, where relevant, (a3), which is 100% by weight.

Polyfunctional isocyanates that can be used are aromatic, aliphatic, cycloaliphatic, and/or araliphatic isocyanates. Polyfunctional isocyanates of this type are known per se or can be produced by methods known per se. The polyfunctional isocyanates can in particular also be used in the form of mixtures, and in this case component (a1) then comprises various polyfunctional isocyanates. Polyfunctional isocyanates that can be used as monomer units (a1) have two or more than two isocyanate groups per molecule of the monomer component (where the term diisocyanates is used below for the former).

Particularly suitable compounds are diphenylmethane 2,2′-, 2,4′-, and/or 4,4′-diisocyanate (MDI), naphthylene 1,5-diisocyanate (NDI), tolylene 2,4- and/or 2,6-diisocyanate (TDI), 3,3′-dimethyldiphenyl diisocyanate, 1,2-diphenylethane diisocyanate, and/or p-phenylene diisocyanate (PPDI), tri-, tetra-, penta-, hexa-, hepta-, and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate, and dicyclohexylmethane 4,4′-, 2,4′-, and/or 2,2′-diisocyanate.

Aromatic isocyanates are preferred as polyfunctional isocyanates (a1). This applies in particular when water is used as component (a3).

The following are particularly preferred embodiments of polyfunctional isocyanates of component (a1):
i) polyfunctional isocyanates based on tolylene diisocyanate (TDI), in particular 2,4-TDI or 2,6-TDI or a mixture of 2,4- and 2,6-TDI;
ii) polyfunctional isocyanates based on diphenylmethane diisocyanate (MDI), in particular 2,2′-MDI or 2,4′-MDI or 4,4′-MDI or oligomeric MDI, which is also termed polyphenyl polymethylene isocyanate, or a mixture of two or three of the abovementioned diphenylmethane diisocyanates, or crude MDI, which arises during the production of MDI, or a mixture of at least one oligomer of MDI and of at least one of the abovementioned low-molecular-weight MDI derivatives;
iii) a mixture of at least one aromatic isocyanate of embodiment i) and of at least one aromatic isocyanate of embodiment ii).

Oligomeric diphenylmethane diisocyanate is particularly preferred as polyfunctional isocyanate. Oligomeric diphenylmethane diisocyanate (termed oligomeric MDI below) involves a mixture of a plurality of oligomeric condensates and therefore of derivatives of diphenylmethane diisocyanate (MDI). The polyfunctional isocyanates can preferably also be composed of mixtures of monomeric aromatic diisocyanates and of oligomeric MDI.

Oligomeric MDI comprises one or more polynuclear condensates of MDI with a functionality of more than 2, in particular 3 or 4 or 5. Oligomeric MDI is known and is often termed polyphenyl polymethylene isocyanate or else polymeric MDI. Oligomeric MDI is usually composed of a mixture of MDI-based isocyanates with different functionality. Oligomeric MDI is usually used in a mixture with monomeric MDI.

The (average) functionality of an isocyanate which comprises oligomeric MDI can vary in the range from about 2.2 to about 5, in particular from 2.4 to 3.5, in particular from 2.5 to 3. This type of mixture of MDI-based polyfunctional isocyanates with different functionalities is in particular crude MDI, which is produced during the production of MDI, usually with catalysis by hydrochloric acid, in the form of intermediate product of crude MDI production.

Polyfunctional isocyanates and mixtures of a plurality of polyfunctional isocyanates based on MDI are known and are marketed by way of example by BASF Polyurethanes GmbH with trademark Lupranat®.

It is preferable that the functionality of component (a1) is at least two, in particular at least 2.2, and particularly preferably at least 2.4. The functionality of component (a1) is preferably from 2.2 to 4 and particularly preferably from 2.4 to 3.

The content of isocyanate groups of component (a1) is preferably from 5 to 10 mmol/g, in particular from 6 to 9 mmol/g, particularly preferably from 7 to 8.5 mmol/g. The person skilled in the art is aware that the content of isocyanate groups in mmol/g and the property known as equivalence weight in g/equivalent have a reciprocal relationship. The content of isocyanate groups in mmol/g is obtained from the content in % by weight in accordance with ASTM D5155-96 A.

In one preferred embodiment, component (a1) is composed of at least one polyfunctional isocyanate selected from diphenylmethane 4,4′-diisocyanate, diphenylmethane 2,4′-diisocyanate, diphenylmethane 2,2′-diisocyanate, and oligomeric diphenylmethane diisocyanate. For the purposes of this preferred embodiment, component (a1) particularly preferably comprises oligomeric diphenylmethane diisocyanate and has a functionality of at least 2.4.

The viscosity of component (a1) used can vary widely. It is preferable that component (a1) has a viscosity of from 100 to 3000 mPa·s, particularly from 200 to 2500 mPa·s.

### Component (a2)

The invention uses, as component (a2), at least one polyfunctional OH-functionalized or NHfunctionalized compound.

For the purposes of the process preferred in the invention, component (a2) is at least one polyfunctional aromatic amine.

Component (a2) can be to some extent produced in situ. In this type of embodiment, the reaction for the purposes of step (a) takes place in the presence of water (a3). Water reacts with the isocyanate groups to give amino groups with release of CO₂. Polyfunctional amines are therefore to some extent produced as intermediate product (in situ). During the course of the reaction, they are reacted with isocyanate groups to give urea linkages.

In this preferred embodiment, the reaction is carried out in the presence of water (a3) and of a polyfunctional aromatic amine as component (a2), and also optionally in the presence of a catalyst (a4).

In another embodiment, likewise preferred, the reaction of component (a1) and of a polyfunctional aromatic amine as component (a2) is optionally carried out in the presence of a catalyst (a4). No water (a3) is present here.

Polyfunctional aromatic amines are known per se to the person skilled in the art. Polyfunctional amines are amines which have, per molecule, at least two amino groups reactive toward isocyanates. Groups reactive toward isocyanates here are primary and secondary amino groups, and the reactivity of the primary amino groups here is generally markedly higher than that of the secondary amino groups.

The polyfunctional aromatic amines are preferably binuclear aromatic compounds having two primary amino groups (bifunctional aromatic amines), corresponding tri- or polynuclear aromatic compounds having more than two primary amino groups, or a mixture of the abovementioned compounds. Particularly preferred polyfunctional aromatic amines of component (a2) are isomers and derivatives of diaminodiphenylmethane.

The bifunctional binuclear aromatic amines mentioned are particularly preferably those of the general formula I,

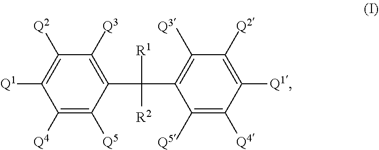

where R¹ and R² can be identical or different and are selected mutually independently from hydrogen and linear or branched alkyl groups having from 1 to 6 carbon atoms, and where all of the substituents Q¹ to Q⁵ and Q^{1′} to Q^{5′} are identical or different and are selected mutually independently from hydrogen, a primary amino group, and a linear or branched alkyl group having from 1 to 12 carbon atoms, where the alkyl group can bear further functional groups, with the proviso that the compound of the general formula I comprises at least two primary amino groups, where at least one of Q¹, Q³, and Q⁵ is a primary amino group, and at least one of Q^{1′}, Q^{3′}, and Q^{5′} is a primary amino group.

In one embodiment, the alkyl groups for the purposes of the substituents Q of the general formula I are selected from methyl, ethyl, n-propyl, isopropyl, n-butyl, sec-butyl, and tert-butyl. Compounds of this type are hereinafter termed substituted aromatic amines (a2-s). However, it is likewise preferable that all of the substituents Q are hydrogen, to the extent that they are not amino groups as defined above (the term used being unsubstituted polyfunctional aromatic amines).

It is preferable that R¹ and R² for the purposes of the general formula I are identical or different and are selected mutually independently from hydrogen, a primary amino group, and a linear or branched alkyl group having from 1 to 6 carbon atoms. It is preferable that R¹ and R² are selected from hydrogen and methyl. It is particularly preferable that R¹═R²═H.

Other suitable polyfunctional aromatic amines (a2) are in particular isomers and derivatives of toluenediamine. Particularly preferred isomers and derivatives of toluenediamine for the purposes of component (a2) are toluene-2,4-diamine and/or toluene-2,6-diamine, and diethyltoluenediamines, in particular 3,5-diethyltoluene-2,4-diamine and/or 3,5-diethyltoluene-2,6-diamine.

It is very particularly preferable that component (a2) comprises at least one polyfunctional aromatic amine selected from 4,4′-diaminodiphenylmethane, 2,4′-diaminodiphenylmethane, 2,2′-diaminodiphenylmethane, and oligomeric diaminodiphenylmethane.

Oligomeric diaminodiphenylmethane comprises one or more polynuclear methylene-bridged condensates of aniline and formaldehyde. Oligomeric MDA comprises at least one, but generally a plurality of, oligomers of MDA having a functionality of more than 2, in particular 3 or 4, or 5. Oligomeric MDA is known or can be produced by methods known per se. Oligomeric MDA is usually used in the form of mixtures with monomeric MDA.

The (average) functionality of a polyfunctional amine of component (a2), where this amine comprises oligomeric MDA, can vary within the range from about 2.3 to about 5, in particular 2.3 to 3.5, and in particular from 2.3 to 3. One such mixture of MDA-based polyfunctional amines having varying functionalities is in particular crude MDA, which is produced in particular during the condensation of aniline with formaldehyde as intermediate product in production of crude MDI, usually catalyzed by hydrochloric acid.

It is particularly preferable that the at least one polyfunctional aromatic amine comprises diaminodiphenylmethane or a derivative of diaminodiphenylmethane. It is particularly preferable that the at least one polyfunctional aromatic amine comprises oligomeric diaminodiphenylmethane. It is particularly preferable that component (a2) comprises oligomeric diaminodiphenylmethane as compound (a2) and that its total functionality is at least 2.1. In particular, component (a2) comprises oligomeric diaminodiphenylmethane and its functionality is at least 2.4.

For the purposes of the present invention it is possible to control the reactivity of the primary amino groups by using substituted polyfunctional aromatic amines for the purposes of component (a2). The substituted polyfunctional aromatic amines mentioned, and stated below, hereinafter termed (a2-s), can be used alone or in a mixture with the abovementioned (unsubstituted) diaminodiphenylmethanes (where all Q in formula I are hydrogen, to the extent that they are not NH₂).

In this embodiment, Q², Q⁴, Q^{2′}, and Q^{4′} for the purposes of the formula I described above, inclusive of the attendant definitions, are preferably selected in such a way that the compound of the general formula I has at least one linear or branched alkyl group, where this can bear further functional groups, having from 1 to 12 carbon atoms in α-position with respect to at least one primary amino group bonded to the aromatic ring. It is preferable that Q², Q⁴, Q^{2′}, and Q^{4′} in this embodiment are selected in such a way that the substituted aromatic amine (a2-s) comprises at least two primary amino groups which respectively have one or two linear or branched alkyl groups having from 1 to 12 carbon atoms in α-position, where these can bear further functional groups. To the extent that one or more of Q², Q⁴, Q^{2′}, and Q^{4′} are selected in such a way that they are linear or branched alkyl groups having from 1 to 12 carbon atoms, where these bear further functional groups, preference is then given to amino groups and/or hydroxy groups, and/or halogen atoms, as these functional groups.

It is preferable that the amines (a2-s) are selected from the group consisting of 3,3′,5,5′-tetraalkyl-4,4′-diaminodiphenylmethane, 3,3′,5,5′-tetraalkyl-2,2′-diaminodiphenylmethane, and 3,3′,5,5′-tetraalkyl-2,4′-diaminodiphenylmethane, where the alkyl groups in 3,3′,5 and 5′ position can be identical or different and are selected mutually independently from linear or branched alkyl groups having from 1 to 12 carbon atoms, where these can bear further functional groups. Preference is given to abovementioned alkyl groups methyl, ethyl, n-propyl, isopropyl, n-butyl, sec-butyl or tert-butyl (in each case unsubstituted).

In one embodiment, one of, a plurality of, or all of, the hydrogen atoms of one or more alkyl groups of the substituents Q can have been replaced by halogen atoms, in particular chlorine. As an alternative, one of, a plurality of, or all of, the hydrogen atoms of one or more alkyl groups of the substituents Q can have been replaced by NH₂ or OH. However, it is preferable that the alkyl groups for the purposes of the general formula I are composed of carbon and hydrogen.

In one particularly preferred embodiment, component (a2-s) comprises 3,3′,5,5′-tetraalkyl-4,4′-diaminodiphenylmethane, where the alkyl groups can be identical or different and are selected independently from linear or branched alkyl groups having from 1 to 12 carbon atoms, where these optionally can bear functional groups. Abovementioned alkyl groups are preferably selected from unsubstituted alkyl groups, in particular methyl, ethyl, n-propyl, isopropyl, n-butyl, sec-butyl, and tert-butyl, particularly preferably from methyl and ethyl. Very particular preference is given to 3,3′,5,5′-tetraethyl-4,4′-diaminodiphenylmethane, and/or 3,3′,5,5′-tetramethyl-4,4′-diaminodiphenylmethane.

The abovementioned polyfunctional amines of component (a2) are known per se to the person skilled in the art or can be produced by known methods. One of the known methods is the reaction of aniline or, respectively, of derivatives of aniline with formaldehyde, with acidic catalysis.

As explained above, water, as component (a3), can to some extent replace the polyfunctional aromatic amine, in that it reacts with an amount, then calculated in advance, of additional polyfunctional aromatic isocyanate of component (a1) in situ to give a corresponding polyfunctional aromatic amine.

The term organic gel precursor (A) is used below for components (a1) to (a3).

### Catalyst (a4)

In one preferred embodiment, the process of the invention is preferably carried out in the presence of at least one catalyst as component (a4).

Catalysts that can be used are in principle any of the catalysts which are known to the person skilled in the art and which accelerate the trimerization of isocyanates (these being known as trimerization catalysts) and/or accelerate the reaction of isocyanates with amino groups (these being known as gel catalysts), and/or—to the extent that water is used—accelerate the reaction of isocyanates with water (these being known as blowing catalysts).

The corresponding catalysts are known per se, and perform in different ways in respect of the abovementioned three reactions. They can thus be allocated to one or more of the abovementioned types according to performance. The person skilled in the art is moreover aware that reactions other than the abovementioned reactions can also occur.

Corresponding catalysts can be characterized inter alia on the basis of their gel to blowing ratio, as is known by way of example from Polyurethane [Polyurethanes], 3rd edition, G. Oertel, Hanser Verlag, Munich, 1993, pp. 104 to 110.

To the extent that no component (a3), i.e. no water, is used, preferred catalysts have significant activity with regard to the trimerization process. This has an advantageous effect on the homogeneity of the network structure, resulting in particularly advantageous mechanical properties.

To the extent that water is used as component (a3), preferred catalysts (a4) have a balanced gel to blowing ratio, so that the reaction of component (a1) with water is not excessively accelerated, with an adverse effect on the network structure, and simultaneously a short gelling time is obtained, and therefore the demolding time is advantageously small. Preferred catalysts simultaneously have significant activity in respect of trimerization. This has an advantageous effect on the homogeneity of the network structure, giving particularly advantageous mechanical properties.

The catalysts can be a monomer unit (incorporable catalyst) or can be non-incorporable.

It is advantageous to use the smallest effective amount of component (a4). It is preferable to use amounts of from 0.01 to 5 parts by weight, in particular from 0.1 to 3 parts by weight, particularly preferably from 0.2 to 2.5 parts by weight, of component (a4), based on a total of 100 parts by weight of components (a1), (a2), and (a3).

Catalysts preferred for the purposes of component (a4) are selected from the group consisting of primary, secondary, and tertiary amines, triazine derivatives, organometallic compounds, metal chelates, quaternary ammonium salts, ammonium hydroxides, and also the hydroxides, alkoxides, and carboxylates of alkali metals and of alkaline earth metals.

Suitable catalysts are in particular strong bases, for example quaternary ammonium hydroxides, e.g. tetraalkylammonium hydroxides having from 1 to 4 carbon atoms in the alkyl moiety and benzyltrimethylammonium hydroxide, alkali metal hydroxides, e.g. potassium hydroxide or sodium hydroxide, and alkali metal alkoxides, e.g. sodium methoxide, potassium ethoxide and sodium ethoxide, and potassium isopropoxide.

Further suitable trimerization catalysts are, in particular, alkali metal salts of carboxylic acids, e.g. potassium formate, sodium acetate, potassium acetate, caesium acetate, ammonium acetate, potassium propionate, potassium sorbate, potassium 2-ethylhexanoate, potassium octanoate, potassium trifluoroacetate, potassium trichloroacetate, sodium chloroacetate, sodium dichloroacetate, sodium trichloroacetate, potassium adipate, potassium benzoate, sodium benzoate, alkali metal salts of saturated and unsaturated long-chain fatty acids having from 10 to 20 carbon atoms, and optionally lateral OH groups.

Other suitable catalysts are in particular N-hydroxyalkyl quaternary ammonium carboxylates, e.g. trimethylhydroxypropylammonium formate.

Examples of suitable organophosphorus compounds, in particular oxides of phospholenes, are 1-methylphospholene oxide, 3-methyl-1-phenylphospholene oxide, 1-phenylphospholene oxide, 3-methyl-1-benzylphospholene oxide.

Organometallic compounds are known per se to the person skilled in the art in particular as gel catalysts and are likewise suitable as catalysts (a4). Organotin compounds, such as tin 2-ethylhexanoate and dibutyltin dilaurate are preferred for the purposes of component (a4). Preference is further given to metal acetylacetonates, in particular zinc acetylacetonate.

Tertiary amines are known per se to the person skilled in the art as gel catalysts and as trimerization catalysts. Tertiary amines are particularly preferred as catalysts (a4). Preferred tertiary amines are in particular N,N-dimethylbenzylamine, N,N′-dimethylpiperazine, N,N-dimethylcyclohexylamine, N,N′,N″-tris(dialkylaminoalkyl)-s-hexahydrotriazines, e.g. N,N′,N″-tris(dimethylaminopropyl)-s-hexahydrotriazine, tris(dimethylaminomethyl)phenol, bis(2-dimethylaminoethyl) ether, N,N,N,N,N-pentamethyldiethylenetriamine, methylimidazole, dimethylimidazole, aminopropylimidazole, dimethylbenzylamine, 1,6-diazabicyclo[5.4.0]undec-7-ene, triethylamine, triethylenediamine (IUPAC: 1,4-diazabicyclo[2,2,2]octane), dimethylaminoethanolamine, dimethylaminopropylamine, N,N-dimethylaminoethoxyethanol, N,N,N-trimethylaminoethylethanolamine, triethanolamine, diethanolamine, triisopropanolamine, and diisopropanolamine, methyldiethanolamine, butyldiethanolamine, and hydroxyethylaniline.

Catalysts particularly preferred for the purposes of component (a4) are selected from the group consisting of N,N-dimethylcyclohexylamine, bis(2-dimethylaminoethyl) ether, N,N,N,N,N-pentamethyldiethylenetriamine, methylimidazole, dimethylimidazole, aminopropylimidazole, dimethylbenzylamine, 1,6-diazabicyclo[5.4.0]undec-7-ene, trisdimethylaminopropylhexahydrotriazine, triethylamine, tris(dimethylaminomethyl)phenol, triethylenediamine (diazabicyclo[2,2,2]octane), dimethylaminoethanolamine, dimethylaminopropylamine, N,N-dimethylaminoethoxyethanol, N,N,N-trimethylaminoethylethanolamine, triethanolamine, diethanolamine, triisopropanolamine, diisopropanolamine, methyldiethanolamine, butyldiethanolamine, hydroxyethylaniline, metal acetylacetonates, acetates, propionates, sorbates, ethylhexanoates, octanoates and benzoates.

The use of the catalysts (a4) preferred for the purposes of the present invention leads to porous materials with improved mechanical properties, in particular to improved compressive strength. Use of the catalysts (a4) moreover reduces the gelling time, i.e. accelerates the gelling reaction, without any adverse effect on other properties.

### Solvent

The organic aerogels or xerogels used in the invention are produced in the presence of a solvent.

For the purposes of the present invention, the term solvent comprises liquid diluents, i.e. not only solvents in the narrower sense but also dispersion media. The mixture can in particular be a genuine solution, a colloidal solution, or a dispersion, e.g. an emulsion or suspension. It is preferable that the mixture is a genuine solution. The solvent is a compound that is liquid under the conditions of the step (a), preferably an organic solvent.

Solvent used can in principle comprise an organic compound or a mixture of a plurality of compounds, where the solvent is liquid under the temperature conditions and pressure conditions under which the mixture is provided (abbreviated to: solution conditions). The constitution of the solvent is selected in such a way that the solvent is capable of dissolving or dispersing, preferably dissolving, the organic gel precursor. For the purposes of the preferred process described above for producing the organic aerogels or xerogels, preferred solvents are those which are a solvent for the organic gel precursor (A), i.e. those which dissolve the organic gel precursor (A) completely under reaction conditions.

The initial reaction product of the reaction in the presence of the solvent is a gel, i.e. a viscoelastic chemical network swollen by the solvent. A solvent which is a good swelling agent for the network formed generally leads to a network with fine pores and with small average pore diameter, whereas a solvent which is a poor swelling agent for the resultant gel generally leads to a coarse-pored network with large average pore diameter.

The selection of the solvent therefore affects the desired pore size distribution and the desired porosity. The selection of the solvent is generally also carried out in such a way as very substantially to avoid precipitation or flocculation due to formation of a precipitated reaction product during or after step (a) of the process of the invention.

When a suitable solvent is selected, the proportion of precipitated reaction product is usually smaller than 1% by weight, based on the total weight of the mixture. The amount of precipitated product formed in a particular solvent can be determined gravimetrically, by filtering the reaction mixture through a suitable filter prior to the gel point.

Solvents that can be used are those known from the prior art to be solvents for isocyanatebased polymers. Preferred solvents here are those which are a solvent for components (a1), (a2), and, where relevant, (a3), i.e. those which substantially completely dissolve the constituents of components (a1), (a2), and, where relevant, (a3) under reaction conditions. It is preferable that the solvent is inert to component (a1), i.e. not reactive thereto.

Examples of solvents that can be used are ketones, aldehydes, alkyl alkanoates, amides, such as formamide and N-methylpyrrolidone, sulfoxides, such as dimethyl sulfoxide, aliphatic and cycloaliphatic halogenated hydrocarbons, halogenated aromatic compounds, and fluorinecontaining ethers. It is also possible to use mixtures made of two or more of the abovementioned compounds.

Acetals can also be used as solvents, in particular diethoxymethane, dimethoxymethane, and 1,3-dioxolane.

Dialkyl ethers and cyclic ethers are also suitable as solvent. Preferred dialkyl ethers are in particular those having from 2 to 6 carbon atoms, in particular methyl ethyl ether, diethyl ether, methyl propyl ether, methyl isopropyl ether, propyl ethyl ether, ethyl isopropyl ether, dipropyl ether, propyl isopropyl ether, diisopropyl ether, methyl butyl ether, methyl isobutyl ether, methyl tert-butyl ether, ethyl-n-butyl ether, ethyl isobutyl ether, and ethyl tert-butyl ether. Particularly preferred cyclic ethers are tetrahydrofuran, dioxane, and tetrahydropyran.

Other preferred solvents are alkyl alkanoates, in particular methyl formate, methyl acetate, ethyl formate, butyl acetate, and ethyl acetate. Preferred halogenated solvents are described in WO 00/24799, page 4, line 12 to page 5, line 4.

Aldehydes and/or ketones are preferred solvents. Aldehydes or ketones suitable as solvents are particularly those corresponding to the general formula R²—(CO)—R¹, where R¹ and R² are hydrogen or alkyl groups having 1, 2, 3 or 4 carbon atoms. Suitable aldehydes or ketones are in particular acetaldehyde, propionaldehyde, n-butyraldehyde, isobutyraldehyde, 2-ethylbutyraldehyde, valeraldehyde, isopentaldehyde, 2-methylpentaldehyde, 2-ethylhexaldehydes, acrolein, methacrolein, crotonaldehyde, furfural, acrolein dimer, methacrolein dimer, 1,2,3,6-tetrahydrobenzaldehyde, 6-methyl-3-cyclohexenaldehyde, cyanacetaldehyde, ethyl glyoxylate, benzaldehyde, acetone, diethyl ketone, methyl ethyl ketone, methyl isobutyl ketone, methyl n-butyl ketone, ethyl isopropyl ketone, 2-acetylfuran, 2-methoxy-4-methylpentan-2-one, cyclohexanone, and acetophenone. The abovementioned aldehydes and ketones can also be used in the form of mixtures. Particular preference is given, as solvents, to ketones and aldehydes having alkyl groups having up to 3 carbon atoms per substituent. Ketones of the general formula R¹(CO)R² are very particularly preferred, where R¹ and R² are mutually independently selected from alkyl groups having from 1 to 3 carbon atoms. In one first preferred embodiment, the ketone is acetone. In another preferred embodiment, at least one of the two substituents R¹ and/or R² comprises an alkyl group having at least 2 carbon atoms, in particular methyl ethyl ketone. Use of the abovementioned particularly preferred ketones in combination with the process of the invention gives porous materials with particularly small average pore diameter. Without any intention of restriction, it is believed that the pore structure of the resultant gel is particularly fine because of the relatively high affinity of the abovementioned particularly preferred ketones.

In many instances, particularly suitable solvents are obtained by using a mixture of two or more compounds which are selected from the abovementioned solvents and which are completely miscible with one another.

It is preferable that components (a1), (a2), and, where relevant, (a3) and, where relevant, (a4), and the solvent are provided in appropriate form prior to the reaction in step (a) of the process of the invention.

It is preferable that components (a1) on the one hand and (a2) and, where relevant, (a3) and, where relevant, (a4) on the other hand are provided separately, in each case in a suitable portion of the solvent. Separate provision permits ideal monitoring or control of the gelling reaction prior to and during the mixing process.

To the extent that water is used as component (a3), it is particularly preferable to provide component (a3) separately from component (a1). This avoids reaction of water with component (a1) with formation of networks in the absence of component (a2). Otherwise, the premixing of water with component (a1) leads to less advantageous properties in respect of the homogeneity of the pore structure and the thermal conductivity of the resultant materials.

The mixture(s) provided prior to conduct of step (a) can also comprise, as further constituents, conventional auxiliaries known to the person skilled in the art. Mention may be made by way of example of surfactant substances, nucleating agents, oxidation stabilizers, lubricants and demolding aids, dyes, and pigments, stabilizers, e.g. with respect to hydrolysis, light, heat, or discoloration, inorganic and/or organic fillers, reinforcing agents, and biocides.

Further details concerning the abovementioned auxiliaries and additives can be found in the technical literature, e.g. in Plastics Additives Handbook, 5th edition, H. Zweifel, ed. Hanser Publishers, Munich, 2001, pages 1 and 41-43.

In order to carry out the reaction in step (a) of the process, it is first necessary to produce a homogeneous mixture of the components provided prior to the reaction in step (a).

The components reacted for the purposes of step (a) can be provided in a conventional manner. It is preferable that a stirrer or other mixing apparatus is used for this purpose, in order to achieve good and rapid mixing. In order to avoid defects in the mixing process, the period necessary for producing the homogeneous mixture should be small in relation to the period within which the gelling reaction leads to the at least partial formation of a gel. The other mixing conditions are generally not critical, and by way of example the mixing process can be carried out at from 0 to 100° C. and at from 0.1 to 10 bar (absolute), in particular by way of example at room temperature and atmospheric pressure. Once a homogeneous mixture has been produced, the mixing apparatus is preferably switched off.

The gelling reaction involves a polyaddition reaction, in particular a polyaddition reaction of isocyanate groups and amino or hydroxy groups.

For the purposes of the present invention, a gel is a crosslinked system based on a polymer in contact with a liquid (terms used being solvogel or lyogel, or if water is used as liquid: aquagel or hydrogel). The polymer phase here forms a continuous three-dimensional network.

For the purposes of step (a) of the process, the gel is usually produced via standing, i.e. simply by allowing the container, reaction vessel, or reactor containing the mixture (termed gelling apparatus below) to stand. It is preferable that during the gelling (gel formation) process the mixture undergoes no further stirring or mixing, because this could inhibit formation of the gel. It has proven advantageous to cover the mixture during the gelling process or to seal the gelling apparatus.

The gelling process is known per se to the person skilled in the art and is described by way of example at page 21, line 19 to page 23, line 13 in WO 2009/027310.

In principle, any solvent can be used as long as it is miscible with carbon dioxide or has a sufficient boiling point which allows for removal of the solvent from the resulting gel. Generally, the solvent will be a low molecular organic compound, i.e. an alcohol having 1 to 6 carbon atoms, preferably 2 to 4, although other liquids known in the art can be used. Possible solvents are, for example, ketones, aldehydes, alkyl alkanoates, amides such as formamide, Nmethylpyrollidone, N-ethylpyrollidone, sulfoxides such as dimethyl sulfoxide, aliphatic and cycloaliphatic halogenated hydrocarbons, halogenated aromatic compounds and fluorinecontaining ethers. Mixtures of two or more of the abovementioned compounds are likewise possible. Examples of other useful liquids include but are not limited to: ethyl acetate, ethyl acetoacetate, acetone, dichloromethane, iso-propanol, methylethylketone, tetrahydrofurane, propylenecarbonate, and the like.

Further possibilities of solvents are acetals, in particular diethoxymethane, dimethoxymethane and 1,3-dioxolane.

Dialkyl ethers and cyclic ethers are likewise suitable as solvent. Preferred dialkyl ethers are, in particular, those having from 2 to 6 carbon atoms, in particular methyl ethyl ether, diethyl ether, methyl propyl ether, methyl isopropyl ether, propyl ethyl ether, ethyl isopropyl ether, dipropyl ether, propyl isopropyl ether, diisopropyl ether, methyl butyl ether, methyl isobutyl ether, methyl t-butyl ether, ethyl n-butyl ether, ethyl isobutyl ether and ethyl t-butyl ether. Preferred cyclic ethers are, in particular, tetrahydrofuran, dioxane and tetrahydropyran.

Aldehydes and/or ketones are particularly preferred as solvent. Aldehydes or ketones suitable as solvent are, in particular, those corresponding to the general formula R²—(CO)—R¹, where R¹ and R² are each hydrogen or an alkyl group having 1, 2, 3, 4, 5, 6 or 7 carbon atoms. Suitable aldehydes or ketones are, in particular, acetaldehyde, propionaldehyde, n-butyraldehyde, isobutyraldehyde, 2-ethylbutyraldehyde, valeraldehyde, isopentaldehyde, 2-methylpentaldehyde, 2-ethylhexaldehyde, acrolein, methacrolein, crotonaldehyde, furfural, acrolein dimer, methacrolein dimer, 1,2,3,6-tetrahydrobenzaldehyde, 6-methyl-3-cyclohexenaldehyde, cyanoacetaldehyde, ethyl glyoxylate, benzaldehyde, acetone, diethyl ketone, methyl ethyl ketone, methyl isobutyl ketone, methyl n-butyl ketone, methyl pentylketone, dipropyl ketone, ethyl isopropyl ketone, ethyl butyl ketone, diisobutylketone, 5-methyl-2-acetyl furan, 2-acetylfuran, 2-methoxy-4-methylpentan-2-one, 5-methylheptan-3-one, 2-heptanone, octanone, cyclohexanone, cyclopentanone, and acetophenone. The abovementioned aldehydes and ketones can also be used in the form of mixtures. Ketones and aldehydes having alkyl groups having up to 3 carbon atoms per substituent are preferred as solvent.

Further preferred solvents are alkyl alkanoates, in particular methyl formate, methyl acetate, ethyl formate, isopropyl acetate, butyl acetate, ethyl acetate, glycerine triacetate and ethyl acetoacetate. Preferred halogenated solvents are described in WO 00/24799, page 4, line 12 to page 5, line 4.

Further suitable solvents are organic carbonates such as for example dimethyl carbonate, diethyl carbonate, ethylene carbonate, propylene carbonate or butylene carbonate.

In many cases, particularly suitable solvents are obtained by using two or more completely miscible compounds selected from the abovementioned solvents.

The process of the present invention can also comprise further steps, for example suitable treatment steps.

The product obtained in the process of the present invention is a porous material with a porosity of preferably at least 70 vol. %, in particular an aerogel. The porous material may be a powder or a monolithic block. The porous material may be an organic porous material or an inorganic porous material.

In further embodiments, the porous material comprises average pore diameters from about 2 nm to about 2000 nm. In additional embodiments, the average pore diameters of dried gel materials may be about 4 nm, about 6 nm, about 8 nm, about 10 nm, about 12 nm, about 14 nm, about 16 nm, about 18 nm, about 20 nm, about 25 nm, about 30 nm, about 35 nm, about 40 nm, about 45 nm, about 50 nm, about 60 nm, about 70 nm, about 80 nm, about 90 nm, about 100 nm, about 200 nm, about 500 nm, about 1000 nm, or about 2000 nm. The size distribution of the pores of the porous material may be monomodal or multimodal according to the present invention.

In the context of the present invention, the surface area, the pore sizes as well as the pore volumes were measured by BET in accordance with ISO 9277:2010 unless otherwise noted. This International Standard specifies the determination of the overall specific external and internal surface area of disperse (e.g. nano-powders) or porous solids by measuring the amount of physically adsorbed gas according to the Brunauer, Emmett and Teller (BET) method. It takes account of the International Union for Pure and Applied Chemistry (IUPAC) recommendations of 1984 and 1994.

According to a further aspect, the present invention is also directed to a porous material, which is obtained or obtainable by the process according to the present invention.

The porous materials obtained or obtainable by the process of the present invention are suitable for different applications.

The present invention is also directed to the use of porous materials as disclosed above or a porous material obtained or obtainable according to a process as disclosed above as thermal insulation material or as core material for vacuum insulation panels.

The invention also relates to construction materials and vacuum insulation panels comprising the porous materials and the use of porous materials for thermal insulation. Preferably, the materials obtained according to the invention are used for thermal insulation especially in buildings, or for cold insulation, particularly in mobile, transportation applications or in stationary applications, for example in cooling devices or for mobile applications.

For mechanical reinforcement for certain applications fibers can be used as additives.

The materials used in thermal insulation materials are preferably used in the following fields of application: as insulation in hollow blocks, as core insulation for multi-shell building blocks, as core insulation for vacuum insulation panels (VIP), as the core insulation for exterior insulation systems, as insulation for cavity wall works, especially in the context of loose-fill insulation.

A further object of the present invention are molded articles, building blocks or modules, building systems and building composites which contain or consist of the porous material according to the present invention. Another object of the present invention are vacuum insulation panels which contain porous materials according to the present invention. Furthermore, the thermal insulation material and the porous materials are in particular suitable for the insulation of extruded hollow profiles, particularly as the core material for the insulation in window frames.

The thermal insulation material is for example an insulation material which is used for insulation in the interior or the exterior of a building or as wall cavity insulation. The porous material according to the present invention can advantageously be used in thermal insulation systems such as for example composite materials.

According to a further aspect, the present invention is also directed to the use of porous material, in particular an inorganic or organic porous material, as disclosed above or a porous material, in particular an inorganic porous material, obtained or obtainable by a process as disclosed above as catalyst support, for the preparation of sensors as additive for food applications or for medical, pharmaceutical and cosmetic applications. It can be preferable to use porous material based on biopolymers, more specifically polysaccharides, for some applications. Within cosmetic applications the porous material, in particular an inorganic or organic porous material, obtained or obtainable by the process of the present invention can be used for example as deodorant active agent which is one method for the treatment of human body odors. These can be provided in all forms which can be envisaged for a deodorant composition. It can be a lotion, dispersion as a spray or aerosol; a cream, in particular dispensed as a tube or as a grating; a fluid gel, dispensed as a roll—an or as a grating; in the form of a stick; in the form of a loose or compact powder, and comprising, in this respect, the ingredients generally used in products of this type which are well known to a person skilled in the art, with the proviso that they do not interfere with the aerogels in accordance with the invention.

The present invention is also directed to the use of porous materials as disclosed above or a porous material obtained or obtainable according to a process as disclosed above as thermal insulation material or for vacuum insulation panels. The thermal insulation material is for example insulation material which is used for insulation in the interior or the exterior of a building. The porous material according to the present invention can advantageously be used in thermal insulation systems such as for example composite materials.

According to a further embodiment, the present invention therefore is directed to the use of porous materials as disclosed above, wherein the porous material is used in interior or exterior thermal insulation systems.

Summarizing, the present invention includes the following embodiments, wherein these include the specific combinations of embodiments as indicated by the respective interdependencies defined therein.

Embodiment 1: Method for manufacturing a body made of a porous material derived from precursors of the porous material in a sol-gel process, comprising
(i) providing a mold, wherein the mold comprises
   a lower part defining an interior volume for receiving the precursors of the porous material, wherein the interior volume defines the shape of the body to be manufactured, and
   at least a first opening through which the body is removable from the lower part, wherein surfaces of the lower part facing the interior volume are at least partially provided with a coating made of a material being electrically dissipative and non-sticky to the precursors of the porous material and/or the body,
(ii) filling precursors of the porous material into the lower part in a first inert or ventilated region, wherein the precursors include two reactive components and a solvent,
(iii) removing the body from the lower part through the first opening after a predetermined time in which the body is formed from the precursors of the porous material,
(iv) disposing the body onto a support, and
(v) removing the solvent from the body.

Embodiment 2: Method according to embodiment 1, wherein the mold further comprises a cover part configured to close the first opening, a second opening, and a lid configured to close the second opening, wherein the method further comprises closing the first opening by means of the cover part, filling precursors of the porous material into the lower part through the second opening, and closing the second opening by means of the lid.

Embodiment 3 Method according to embodiment 2, further comprising closing the first opening and/or the second opening in a gas tight manner.

Embodiment 4: Method according to embodiment 2 or 3, further comprising removing the cover part from the lower part in a second inert or ventilated region after a predetermined time in which the body is formed from the precursors of the porous material.

Embodiment 5: Method according to any one of embodiments 1 to 4, wherein removing the body from the lower part and disposing the body onto the support includes disposing the support onto the lower part and turning the lower part together with the support.

Embodiment 6: Method according to embodiment 5, further comprising fixing the support onto the lower part.

Embodiment 7: Method according to any one of embodiments 1 to 6, further comprising mixing the precursors before being filled into the lower part.

Embodiment 8: Method according to any one of embodiments 1 to 7, wherein the support comprises openings.

Embodiment 9: Method according to any one of embodiments 1 to 8, further comprising buffering the body in a third inert region before removing the solvent from the body.

Embodiment 10: Method according to any one of embodiments 1 to 8, further comprising buffering a plurality of bodies in a third inert region and simultaneously removing the solvent from the plurality of bodies.

Embodiment 11: Method according to embodiment 10, further comprising repeating steps (i) to (iv) a predetermined number of times in a subsequent order so as to provide the plurality of bodies.

Embodiment 12: Method according to embodiment 10 or 11, wherein a volume of the third inert region is adapted to a total volume of the plurality of bodies and/or the third inert region is filled, particularly pre-saturated, with vapor of the solvent such that a substantial shrinking of the gel is prevented.

Embodiment 13: Method according to any one of embodiments 9 to 12, further comprising sealing the third inert region in a gas tight manner.

Embodiment 14: Method according to any one of embodiments 9 to 13, wherein the third inert region is defined by a chamber.

Embodiment 15: Method according to embodiment 14, wherein the chamber defined by the third inert region comprises an airlock.

Embodiment 16: Method according to any one of embodiments 4 to 15, wherein the first inert or ventilated region and/or the second inert or ventilated region are defined by a chamber.

Embodiment 17: Method according to any one of embodiments 4 to 16, further comprising repeating steps (i) to (iv) a predetermined number of times in a subsequent order so as to provide a plurality of bodies, wherein a volume of the first inert or ventilated region and/or second inert or ventilated region is adapted to a total volume of the plurality of bodies.

Embodiment 18: Method according to any one of embodiments 4 to 17, further comprising sealing the first inert or ventilated region and/or second inert or ventilated region in a gas tight manner.

Embodiment 19: Method according to any one of embodiments 1 to 18, wherein removing the solvent from the body is performed by means of an autoclave or oven.

Embodiment 20: Method according to any one of embodiments 1 to 19, further comprising reusing the coating for at least 50 cycles of the sol gel process.

Embodiment 21: Method according to any one of embodiments 4 to 20, the first inert or ventilated region is an inert region filled or pre-saturated with vapor of the solvent and/or second inert or ventilated region is an inert region filled or pre-saturated with vapor of the solvent filled or pre-saturated with vapor of the solvent.

Embodiment 22: Method according to embodiment 16, wherein the first region is a ventilated region and/or the second region is a ventilated region, wherein the chamber comprises an airlock.

Embodiment 23: A porous material, which is obtained or obtainable by the process according to any of embodiments 1 to 22.

Embodiment 24: The use of porous materials according to embodiment 23 or a porous material obtained or obtainable by the process according to any of embodiments 1 to 22 as thermal insulation material or for vacuum insulation panels.

Embodiment 25: The use according to embodiment 24, wherein the porous material is used in interior or exterior thermal insulation systems.

### SHORT DESCRIPTION OF THE FIGURES

Further features and embodiments of the invention will be disclosed in more detail in the subsequent description, particularly in conjunction with the dependent claims. Therein the respective features may be realized in an isolated fashion as well as in any arbitrary feasible combination, as a skilled person will realize. The embodiments are schematically depicted in the figures. Therein, identical reference numbers in these figures refer to identical elements or functionally identical elements.

In the Figures:

FIG. 1 shows a perspective view of a mold in an open state useable with the method according to the present invention;

FIG. 2 shows a perspective view of the mold in a closed state;

FIG. 3 shows a flow chart of the method according to the present invention; and

FIG. 4 shows a perspective view of a demolding apparatus for removing a body from the mold.

### DETAILED DESCRIPTION

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Further, as used in the following, the terms “particularly”, “more particularly”, “specifically”, “more specifically” or similar terms are used in conjunction with additional/alternative features, without restricting alternative possibilities. Thus, features introduced by these terms are additional/alternative features and are not intended to restrict the scope of the claims in any way. The invention may, as the skilled person will recognize, be performed by using alternative features. Similarly, features introduced by “in an embodiment of the invention” or similar expressions are intended to be additional/alternative features, without any restriction regarding alternative embodiments of the invention, without any restrictions regarding the scope of the invention and without any restriction regarding the possibility of combining the features introduced in such way with other additional/alternative or non-additional/alternative features of the invention.

Further, it shall be noted that the terms “first”, “second” and “third” are used to exclusively facilitate to differ between the respective constructional members or elements and shall not be construed to define a certain order or importance.

The term “mold” as used herein refers to a hollowed-out block or container that is configured to be filled with a liquid or pliable material provided by precursors of a sol gel provided by precursors of a sol gel. Particularly, the sol-gel process is carried out within the mold. During the sol-gel process the precursors form a sol which subsequently starts to gel. Thus, the liquid hardens or sets inside the mold, adopting its shape defined by the interior volume thereof. The mold is basically used to carry out the sol-gel process. However, it is to be noted that the solvent may be removed from the thus formed gel with the gel remaining within the mold or with the gel removed from the mold. In the present invention, the mold may consist of more than one part, wherein the interior volume is defined by a lower part.

The term “sol gel process” as used herein refers to a method for producing solid materials from small molecules. In the present case, the method is used for the fabrication of porous materials such as aerogels, xerogels and/or kryogels. The process involves conversion of monomers as precursors into a colloidal solution, the so-called sol, that subsequently reacts to an integrated network, the so-called gel, of either discrete particles or network polymers. In this chemical procedure, the sol gradually evolves towards the formation of a gel-like diphasic system containing both a liquid phase and solid phase whose morphologies range from discrete particles to continuous polymer networks. This gel-like diphasic system is called gel. Particularly, the gel encapsulates or surrounds the solvent within pores which are connected to one another, i.e. the pores form an interpenetrating network. Removal of the remaining liquid phase, i.e. the solvent, requires a drying process, which is typically accompanied by a certain amount of shrinkage and densification. The rate at which the solvent can be removed is ultimately determined by the distribution of porosity in the gel. The ultimate microstructure of the final component will clearly be strongly influenced by changes imposed upon the structural template during this phase of processing.

The term “body” as used herein refers to a solid object formed by an identifiable collection of matter, which may be constrained by an identifiable boundary, and may move or may be moved as a unit by translation or rotation, in 3-dimensional space.

The term “porous” as used herein refers to material characteristics of having pores. As the solvent may be removed from the gel either with the gel being or remaining within the mold or after the gel is removed from the mold, the term “porous” covers both pores being filled with a liquid, particularly, the solvent, or a gas such as air. The pores may be connected to one another so as to form a type of network.

The term “coating” as used herein refers to a covering that is applied to the inner surfaces of the lower part of the mold. Particularly, the coating may be applied at least to those areas of the lower part intended to come into contact with the precursors of the porous material and the body made thereof. Needless to say, the coating may be applied to the total inner surfaces of the lower part defining the interior volume.

The term “electrically dissipative” as used herein refers to material characteristics, wherein electric charges are allowed to flow to ground but more slowly in a more controlled manner if compared to electrically conductive materials.

The term “non-sticky” as uses herein refers to characteristics wherein one part does not adhere to another part. Thus, both parts are in loose contact to one another. According to the present invention, the coating does not stick to the gel formed or resulting from the precursors filled into the mold. In case the solvent used with the sol gel process is removed with the gel being within the mold, the coating is configured not to stick to the thus formed body in order to allow the body being removed from the mold.

The terms “width” and “length” of the shape of the body as used herein refer to dimensions perpendicular to a height or thickness of the shape of the body.

The term “opening area” as used herein refers to the area of an opening defined by the boundary of the opening.

The term “sealing” as used herein refers to a device that helps join two parts together by preventing leakage, containing pressure, or excluding contamination.

The term “gas tight” as used herein refers to characteristics of a material to be impermeable to gases. Needless to say, the impermeability is not feasible to a complete or absolute extension but the impermeability is to be understood in the sense of an extension as far as technically feasible.

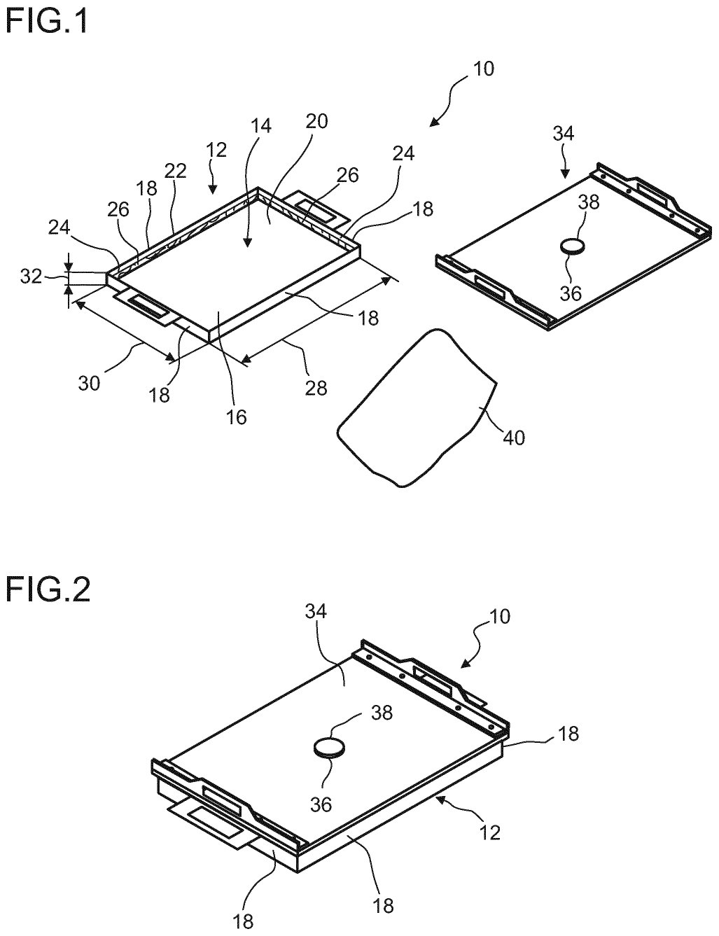

FIG. 1 shows a perspective view of a mold 10 for manufacturing a body made of a porous material derived from precursors of the porous material in a sol-gel process carried out within the mold 10 according to the present invention. The mold 10 is shown in an open state. The mold 10 comprises a lower part 12. The lower part 12 is made of metal. The lower part 12 defines an interior volume 14 for receiving the precursors of the porous material. The interior volume 14 defines the shape of the body to be manufactured. Particularly, the lower part 12 comprises a bottom 16 and side walls 18 extending from the bottom 16. The interior volume 14 is defined by the bottom 16 and the side walls 18. The mold 10 further comprises at least a first opening 20 through which the body is removable from the lower part 12. In the present example, the lower part 12 comprises the first opening 20. Particularly, an upper rim 22 of the side walls 18 opposite to the bottom 16 defines the first opening 20.

Surfaces 24 of the lower part 12 facing the interior volume 14 are at least partially provided with a coating 26 made of a material being electrically dissipative and non-sticky to a gel formed from the precursors of the porous material and/or the body. More particularly, the surfaces 24 of the lower part 12 comprise the coating 26 at least at areas intended for coming into contact with the gel formed from the precursors of the porous material. With other words, the coating 26 does not need to cover the complete surfaces 24 of the lower part which face the interior volume 14 but may only cover those portions or areas which are intended to come into contact with the precursors of the porous material. The material of the coating 26 comprises an electrical resistivity of not more than 10⁸ Ωm such as 10⁶ Ωm. The material of the coating 26 is noncorroding. The material of the coating 26 comprises a shore hardness in a range of D60 to D80 such as D70. The coating 26 comprises a thickness in a range of 20 μm to 70 μm such as 50 μm. The coating 26 is a reusable coating. Particularly, the coating 26 is reusable for at least 50 and preferably at least 100 cycles of the sol gel process. The coating preferably comprises at least one halogen-containing polymer and at least one inorganic filler. More preferably, the halogen-containing polymer is a fluorinated polymer such as for example polytetrafluoroethylene, a perfluoro alkoxy polymer or a fluorinated ethylene propylene polymer. The coating preferably comprises at least one inorganic filler and at least one polymer selected from the group consisting of polytetrafluoroethylene, perfluoro alkoxy polymers and fluorinated ethylene propylene polymers. Particularly preferred are fluorinated ethylene propylene polymers such as perfluoro ethylene propylene. In the present embodiment, the coating 26 is made of a fluorinated polymer with conductive additive and anti-scratch additive. Such a material is commercially available under the name Rhenolease MK IIIG clear SiC/leitf. (hereinafter called Rhenolease) from the company Rhenotherm Kunststoffbeschichtungs GmbH, 47906 Kempen, Germany.

Basically, the interior volume 14 may define any shape for the body such as round, oval, elliptical, polygonal, polygonal with rounded edges. In the present example, the interior volume 14 defines a cuboid shape for the body. The shape has a length 28 in a range of 10 cm to 100 cm such as 60 cm and a width 30 in a range of 10 cm to 100 cm such as 40 cm. A height 32 of the shape is variable and may be adjusted by means of the filling level of the precursors within the lower part 12.

The mold 10 further comprises a cover part 34 configured to close the first opening 20, a second opening 36, and a lid 38 configured to close the second opening 36. In the present example, the cover part 34 comprises the second opening 36. The first opening 20 comprises a first opening area and the second opening 36 comprises a second opening area. The second opening area is smaller than the first opening area. The mold 10 further comprises at least a first sealing 40 configured to be arranged between the lower part 12 and the cover part 34. The first sealing 40 is configured to provide a gas tight closing of the first opening 20 by means of the cover part 34. Optionally, the mold 10 may further comprises a second sealing (not shown in detail) configured to be arranged between the lid 38 and the cover part 34 and configured to provide a gas tight closing of the second opening 36 by means of the lid 38.

FIG. 2 shows a perspective view of the mold 10 in a closed state. Particularly, the cover part 34 is arranged on the lower part 12 such that the first opening 20 is closed. The cover part 34 is removably mounted to the lower part 12. For example, the cover part 34 may be connected to the lower part 12 by means of a snap-fit connection, screws, hooks or the like. Further, the lid 38 closes the second opening 36.

The mold 10 may be used as follows. The cover part 34 is disposed onto the lower part 12 with the first opening 20 being closed. The precursors of the porous material, which are solved in a solvent, are filled into the lower part 12 up to a predetermined amount through the second opening 36. Subsequently, the second opening 36 is closed by the lid 38. Thereby, any solvent vapor is prevented from leaking or releasing from the mold 10. Then, the sol-gel reaction takes place wherein the precursors first form a sol with the solvent and subsequently form a gel. After gelling, the gel is hardened for a predetermined time such as at least 2 hours and preferably at least 8 hours. The hardening causes a kind of ageing of the gel which is necessary for the sol-gel reaction to proceed far enough such that the gel can be removed from the mold. If the sol-gel reaction was not to proceed far enough, the gel might not be sufficiently mechanically stable for handling, particularly for drying, or unreacted material could leak out of the gel during drying or could cause other problems such as negative impact on performance, e.g. fire behavior, unwanted emissions. After hardening, the cover part 34 is removed from the lower part 12. Thereby, the first opening 20 is exposed again. Then, the solvent is removed from the gel. The solvent may be removed by drying the gel in an oven or the like. It is to be noted that the solvent may be removed while the gel is in the lower part 12 or the gel may be removed from the lower part 12 before the gel is dried. After the solvent is removed from the gel, the body is formed. If the gel has been dried within the lower part 12, the body may subsequently be removed from the mold 10 and lower part 12, respectively. Due to the specific coating 26, neither the gel formed from the precursors within the lower part 12 nor the body sticks to the mold 10. If it is intended to remove the solvent with the gel being removed from the lower part 12 of the mold 10, the material of the coating may be selected such that it merely does not stick to the formed gel.

The mold 10 may be modified as follows. The lower part 12 may be made of a polymer. The coating 26 may completely cover the surfaces 24 facing the interior volume 14 or may even cover the complete lower part 12. The mold 12 may be used without the cover part 34 if an excessive release of any solvent vapor is otherwise prevented. The second opening 36 may be provided at the lower part 12. The shape of the body may be any shape such as square, rounded or the like. The mold 10 may comprise more parts than the lower part 12 and the cover part 34 such as an intermediate part arrangeable between the lower part 12 and the cover part 34.

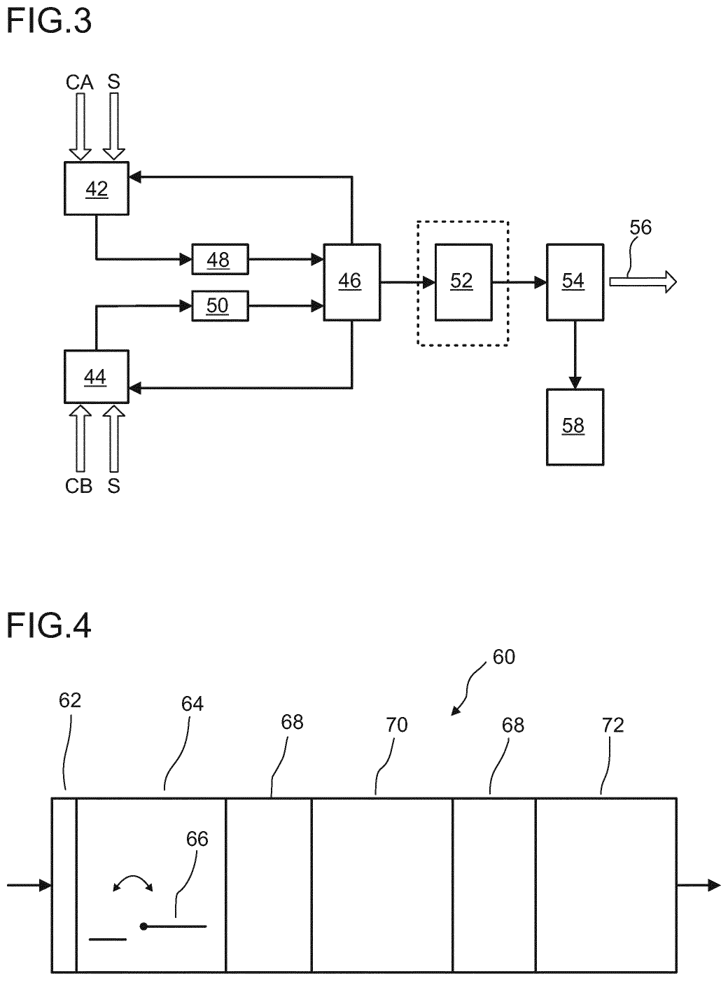

FIG. 3 shows a flow chart of a method for manufacturing a body made of a porous material derived from precursors of the porous material in a sol-gel process according to the present invention. The mold 10 is provided. The cover part 34 is disposed onto the lower part 12 with the first opening 20 being closed. Particularly, the first opening 20 is closed in a gas tight manner by means of the cover part 34 and the first sealing 40. The precursors of the porous material are prepared. In the present example, a first reactive component CA and a solvent S are supplied to a first receiving tank 42. Further, a second reactive component CB and the solvent S are supplied to a second receiving tank 44. A predetermined amount of the first reactive component and solvent is supplied to a mixing device 46 from the first receiving tank 42. In the present example, the predetermined amount is defined as a volumetric dosing by means of a first volumetric dosing device 48. A predetermined amount of the second reactive component and solvent is supplied to the mixing device 46 from the second receiving tank 44. In the present example, the predetermined amount is defined as a volumetric dosing by means of a second volumetric dosing device 50. Optionally, a closed loop operation may be provided with the first receiving tank 42 and the mixing device 46 and/or with the second receiving tank 46 and the mixing device 46.

The precursors of the porous material are filled into the lower part 12 up to a predetermined amount through the second opening 36. In the present example, the filling process is carried out by means of the mixing device 46. Particularly, the precursors are mixed by means of the mixing device 46 before being filled into the lower part 12. The precursors are filled into the lower part 12 in a first inert or ventilated region 52. For example, the filling is carried out in a carbon dioxide atmosphere or in a device similar to a laboratory hood. The first inert or ventilated region 52 may be defined by a chamber. The first inert or ventilated region 52 may be sealed in a gas tight manner. Subsequently, the second opening 36 is closed by the lid 38. Particularly, the second opening 36 is closed in a gas tight manner. Thereby, any solvent vapor is prevented from leaking from the mold 10. Then, the sol gel reaction from the two reactive components of the precursors takes place wherein the precursors gel. After gelling, the gel is hardened or aged for a predetermined time such as at least 3 hours and preferably at least 8 hours in order to complete the gelation reaction and to exclude a negative impact on the further handling of the gel body such as in case the gel body is not sufficiently hard. In the present example, the hardening or ageing process is carried out by means of a hardening device 54. In the hardening device 54, a plurality of molds 10 including the gel may be buffered. After hardening, the body is formed and the cover part 34 may be removed from the lower part 12. Thereby, the first opening 20 is exposed again and the body may be removed from the mold 10 and lower part 12, respectively, as indicated by arrow 56. That is, the body is removed from the lower part 12 through the first opening 20 after a predetermined time in which the body is formed from the precursors of the porous material. Due to the specific coating 26, the body does not stick to the mold 10. Further, the solvent is recycled or re-extracted by means of a re-extraction device 58. Hereinafter, the further handling for removing of the body from the lower part 12 and subsequent method steps will be described in further detail.

FIG. 4 shows a perspective view of a demolding apparatus 60 for removing a body from the mold 10. The mold 10 is transported in the closed state to an input 62 of the demolding apparatus 60. For example, the closed mold 10 is transported on a carriage or the like. The input 62 is located adjacent a second inert or ventilated region 64. The second inert or ventilated region 64 may be defined by a chamber. The second inert or ventilated region 64 may be sealed in a gas tight manner. A door (not shown in detail) similar to the door of a laboratory hood between the input 62 and the second inert or ventilated region 64 is opened and the closed mold 10 is disposed within the second inert or ventilated region 64. The cover part 34 is removed from the lower part 12 in the second inert or ventilated region 64 after a predetermined time in which the body is formed from the precursors of the porous material. Further, the door is closed. The body is disposed onto a support 66. For this purpose, the support 66 is disposed and fixed onto the lower part 12. For example, the support 66 is pneumatically fixed onto the lower part 12. Further, the lower part 12 together with the support 66 are turned, preferably at 180° such that lower part 12 is arranged onto the support 66. The turning may be carried out by means of a lever (not shown in detail). Due to gravity, the body moves out of the lower part 12 and onto the support 66. The lever is moved into its initial position such that the empty lower part 12 may be removed from the second inert or ventilated region 64 when the door is opened. The support 66 comprises openings (not shown in detail).

The chamber defining the second inert or ventilated region 64 comprises an airlock 68 by means of which the second inert or ventilated region 64 is connected to a third inert region 70 before the solvent is removed from the body. The third inert region 70 is defined by a chamber. The third inert region 70 includes an atmosphere of carbon dioxide, nitrogen, argon or the like. The body is transported from the second inert or ventilated region 64 to the third inert region 70 through the airlock 68. For this purpose, the airlock 68 comprises a first door (not shown in detail) allowing a communication of the airlock 68 with the second inert or ventilated region 64 and a second door (not shown in detail) allowing a communication of the airlock 68 with the third inert region 70. First, the first door is opened while the second door is closed. Then the body is transported into the airlock 68. The body is transported into the airlock 68 by means of a first conveyor such as a chain conveyor. Subsequently, the first door is closed while the second door is still closed. Then, the airlock 68 is rendered inert. Subsequently, the second door is opened while the first door remains closed. Then, the body is transported from the airlock 68 into the third inert region 70 by means of a second conveyor such as a chain conveyor. It is to be noted that this transport through the airlock 68 is carried out rather fast in a time of not more than 30 seconds in order to avoid an excessive loss of the solvent from the body.

The body is buffered in the third inert region 70. The third inert region 70 is sealed in a gas tight manner so as to avoid any leakage of solvent therefrom. It is to be noted that the method steps described before may be repeated a predetermined number of times in a subsequent order so as to provide a plurality of bodies, which are buffered in the third inert region 70. As mentioned above, the support 66 comprises openings. Thus, a diffusion of the solvent from the body is possible on all sides thereof. Needless to say, the support 66 is stable so as to avoid any deformation of the support and the body disposed thereon. Preferably, a volume of the third inert region 70 is adapted to a total volume of the plurality of bodies which means that only a small amount of the solvent may evaporate from the body up to a degree of saturation in the atmosphere of the third inert region 70 such that a substantial shrinking of the gel is prevented. In addition or alternatively, the third inert region 70 is already filled or even pre-saturated with vapor of the solvent such that the degree of saturation is already achieved or is achieved rather fast. The third inert region 70 may be provided with positive pressure in order to prevent oxygen to enter the third inert region 70.

After buffering the body or the plurality of bodies, the body or the plurality of bodies are transported to an autoclave or oven 72. The third inert region 70 may have an airlock 68 communicating with the third inert region 70 and the oven 72. This transport may be carried out on a carriage having mounts for mounting the supports 66. The solvent is removed from the body or the plurality of bodies is performed by means of the autoclave or oven 72. Preferably, autoclave or oven 72 is supplied with a plurality of bodies and the solvent of the plurality of bodies is removed simultaneously. After removing the solvent from the body or the plurality of bodies, the body or the plurality of bodies are finalized, removed from the autoclave or oven 72 and ready to be used. As the bodies do not stick to the coating 26 of the lower part, the coating 26 may be reused for at least 50 cycles of the sol gel process.

The mold 10 may be modified as follows. The lower part 12 may be made of a polymer. The coating 26 may completely cover the surfaces 14 facing the interior volume 14 or may even cover the complete lower part 12. The mold 12 may be used without the cover part 34 if used within an inert atmosphere. The second opening 36 may be provided at the lower part 12. The shape of the body may be any shape such as square, rounded or the like. The mold 10 may comprise more parts than the lower part 12 and the cover part 34 such as an intermediate part arrangeable between the lower part 12 and the cover part 34. The support 66 may also be provided with the coating 26.

### EXAMPLES

The mold 10 and more particularly the material of the coating 26 are specified in further detail as follows.

The following components were prepared:

Component 1: To methylethylketone (MEK) were added 3-4% MDEA, 1,5-2,5% potassium sorbate solution (20% in methylene glycol), 1,8-3,5% n-butanol.

Component 2: To MEK were added 15-20% polymeric MDI.

Components 1 and 2 were combined at room temperature and directly poured into a mold to form a gel slab. The mold was covered to prevent evaporation of the solvent from the gel. After 1 h, the cover was removed and the mold was inverted to demold the gel slab.

With these materials, a solvent vapor emission from the resulting gel has been detected as 65 g/(min×m²). The solvent vapor emission rate was detected by weighing the gel periodically and determining the weight loss due to the vapor emission. A maximum solvent loss before quality impact due to pore damage is given as 10 wt % based on empiric considerations. The mold comprised a geometry so as to produce cuboid gel slabs each having length of 0.6 m, a width of 0.42 m and a thickness of 20 mm. Each slab comprises 3.5 kg solvent. The demolding time, i.e. the time necessary to remove the body from the mold, was given as 1 min per gel slab. According to hazardous materials regulations in Germany, the lower explosion limit (LEL) of MEK is defined as 45 g/m³ and the upper explosion limit (UEL) of MEK is defined as 378 g/m³. The maximum safe working concentration MAK (German MAK−Maximale Arbeitsplatz-Konzentration=threshold limit value) for MEK is defined as 600 mg/m³. In the followings examples concerning inert regions or areas, the inertization was made with N₂ having a saturation concentration of MEK of 301 g/m³ at a pressure of 10⁵ Pa and a temperature of 20° C. Concerning the following examples, 100 open molds were considered with 100 gel slabs, wherein 0.25 m² (=0.6 m length×0.42 m width) surface area of the gel slab faces the room. Thus, a solvent evaporation was defined as 100 slabs×0.25 m²/slab×65 g/(min×m²)=1625 g/min MEK corresponding to an evaporation from 1 gel slab of 16.3 g/min MEK. For the following examples, 100 gel slabs were buffered e.g. during demolding until all slabs have been demolded.

### Example 1

A non-ventilated room or area of 5×5×5 m³ for 100 slabs was analyzed. An open mold was used. The explosion hazard with the above-identified solvent can be calculated as 45 g/m³×125 m³=5625 g. Thus, the LEL in the room or area is reached in 5625 g/1625 g/min=3.5 min. Accordingly, the explosion hazard is relevant in example 1. The health hazard with the above-identified solvent can be calculated as 600 mg/m³×125 m³=75 g solvent in total. This threshold is met in 75 g/1625 g/min=0.05 min. Thus, the MAK for the above-identified solvent is reached in significantly less than 1 min. Accordingly, the health hazard is relevant. The quality impact can be calculated as 10 wt %×3.5 kg solvent=350 g MEK loss tolerated per gel slab. The evaporation rate is 0.25 m²×65 g/(min×m²)=16.3 g/min MEK. The time to quality loss is 350 g/16.3 g/min=21 min. Accordingly, there is not enough time for buffering and demolding which has to be carried out in 100 min for all 100 slabs. Accordingly, a negative impact on quality is relevant. Further, an environmental impact and waste air treatment based on a MEK emission of 1625 g/min is relevant.

### Example 2

A closed mold was used representing a non-ventilated room or area of 0.6×0.42×0.05 m³=0.0126 m³ for 1 slab. The explosion hazard with the above-identified solvent can be calculated for the LEL as 45 g/m³×0.0126 m³=0.57 g solvent in total. The LEL is met in 0.57 g/16.3 g/min=0.035 min. Thus, the LEL in the mold is reached in approximately 2 s. The explosion hazard with the above-identified solvent can be calculated for the UEL as 378 g/m³×0.0126 m³=4.8 g solvent in total. The UEL is met in 4.8 g/16.3 g/min=0.294 min. So a non-explosive atmosphere is reached very fast. The UEL in the mold is reached in approximately 18 s. Nevertheless, in this respect, it has to be noted that if the closed mold is constructed according to explosion-protection standards, no explosion hazard is given as there is no ignition source in a closed mold. With a closed mold, there is no health hazard. The quality impact can be calculated as 10 wt %×3.5 kg solvent=350 g MEK loss tolerated per gel slab. The amount of MEK until saturation is calculated as 301 g/m³ (saturation concentration of MEK)×0.0126 m³=approximately 4 g. Thus, there is no quality impact. Further, with a closed mold, there is no environmental impact.

### Example 3

A ventilated room or area of 5×5×5 m³ for 100 slabs was analyzed with a 20 times air exchange per hour. An open mold was used.

The respective calculations are identified in table 1 given below. In table 1, the first column from the left gives the time. The second column from the left gives the emission of the solvent per slab. The third column from the left gives the emission of the solvent of all 100 slabs. The fourth column from the left gives the amount of solvent in the room before air exchange. The fifth column from the left gives the concentration of solvent in the room before air exchange. The sixth column from the left gives the ventilation rate per hour. The seventh column from the left gives the ventilation rate per minute. The eighth column from the left gives the volume exchange per minute. The ninth column from the left gives the concentration of solvent in the room after air exchange. The tenth column from the left gives the amount of solvent in the room after air exchange.

TABLE 1

| | | | m (room, before) | | | | Volume | c (room, after) | m (room, after) |
|---|---|---|---|---|---|---|---|---|---|
| | Emission | | before air exchange | c (room, before) | | | exchange | afterair exchange | air exchange |
| | slab | m (emission) | [g] | before air exchange | Venti- | Venti- | [/min] | [g/m3] | [g] |
| Time | [g/min] | all slabs | m (after) + | [g/m3] | lation | lation | Venti- | (1 − Vol. exch.)*c | c (room, |
| [min] | R*A | [g/min] | m (emission) | m (room, before)/V | [m3/h] | [m3/min] | lation/V | (room, before) | after)*V |
| 0 | | | | | | | | | 0 |
| 1 | 16.25 | 1625 | 1625 | 13.0 | 2500 | 41.7 | 0.33 | 8.7 | 1083 |
| 2 | 16.25 | 1625 | 2708 | 21.7 | 2500 | 41.7 | 0.33 | 14.4 | 1806 |
| 3 | 16.25 | 1625 | 3431 | 27.4 | 2500 | 41.7 | 0.33 | 18.3 | 2287 |
| 4 | 16.25 | 1625 | 3912 | 31.3 | 2500 | 41.7 | 0.33 | 20.9 | 2608 |
| 5 | 16.25 | 1625 | 4233 | 33.9 | 2500 | 41.7 | 0.33 | 22.6 | 2822 |
| 6 | 16.25 | 1625 | 4447 | 35.6 | 2500 | 41.7 | 0.33 | 23.7 | 2965 |
| 7 | 16.25 | 1625 | 4590 | 36.7 | 2500 | 41.7 | 0.33 | 24.5 | 3060 |
| 8 | 16.25 | 1625 | 4685 | 37.5 | 2500 | 41.7 | 0.33 | 25.0 | 3123 |
| 9 | 16.25 | 1625 | 4748 | 38.0 | 2500 | 41.7 | 0.33 | 25.3 | 3165 |
| 10 | 16.25 | 1625 | 4790 | 38.3 | 2500 | 41.7 | 0.33 | 25.5 | 3194 |
| 11 | 16.25 | 1625 | 4819 | 38.5 | 2500 | 41.7 | 0.33 | 25.7 | 3212 |
| 12 | 16.25 | 1625 | 4837 | 38.7 | 2500 | 41.7 | 0.33 | 25.8 | 3225 |
| 13 | 16.25 | 1625 | 4850 | 38.8 | 2500 | 41.7 | 0.33 | 25.9 | 3233 |
| 14 | 16.25 | 1625 | 4858 | 38.9 | 2500 | 41.7 | 0.33 | 25.9 | 3239 |
| 15 | 16.25 | 1625 | 4864 | 38.9 | 2500 | 41.7 | 0.33 | 25.9 | 3243 |
| 16 | 16.25 | 1625 | 4868 | 38.9 | 2500 | 41.7 | 0.33 | 26.0 | 3245 |
| 17 | 16.25 | 1625 | 4870 | 39.0 | 2500 | 41.7 | 0.33 | 26.0 | 3247 |
| 18 | 16.25 | 1625 | 4872 | 39.0 | 2500 | 41.7 | 0.33 | 26.0 | 3248 |
| 19 | 16.25 | 1625 | 4873 | 39.0 | 2500 | 41.7 | 0.33 | 26.0 | 3249 |
| 20 | 16.25 | 1625 | 4874 | 39.0 | 2500 | 41.7 | 0.33 | 26.0 | 3249 |

As can be taken from table 1, particularly the ninth column from the left, the LEL of 45 g/m³ is not reached as an approximation of the concentration of the solvent in the room of maximum 26 g/m³ occurs. Thus, there is no explosion hazard. As with example 1, the MAK is reached in significantly less than 1 min. Thus, the health hazard is relevant. Accordingly, the health hazard is relevant. The quality impact can be calculated as 10 wt %×3.5 kg solvent=350 g MEK loss tolerated per gel slab. The evaporation rate is 0.25 m²×65 g/(min×m²)=16.3 g/min MEK. The time to quality loss is 350 g/16.3 g/min=21 min. Accordingly, there is not enough time for buffering and demolding which has to be carried out in 100 min for all 100 slabs. Accordingly, a negative impact on quality is relevant. Further, an environmental impact and waste air treatment based on a MEK emission of 1625 g/min is relevant.

### Example 4

An inert room or area of 5×5×5 m³ for 100 slabs was analyzed. In an inert atmosphere, there is no explosion hazard. Further, in an inert atmosphere, there is no health hazard as human beings are not exposed to this atmosphere. The quality impact can be calculated as 10 wt %×3.5 kg solvent=350 g MEK loss tolerated per gel slab. The amount of MEK until saturation is 301 g/m³×125 m³=37.5 kg. The MEK loss distributed across all gel slabs is 37.5 kg/100 slabs=375 g/slab which is higher than the 350 g limit. Thus, the negative impact on quality is partially relevant. As there is no MEK emission outside of the inert room or area, there is no environmental impact.

### Example 5

An inert room or area with a reduced volume of 3×3×3 m³ for 100 slabs was analyzed. In an inert atmosphere, there is no explosion hazard. Further, in an inert atmosphere, there is no health hazard as human beings are not exposed to this atmosphere. The quality impact can be calculated as 10 wt %×3.5 kg solvent=350 g MEK loss tolerated per gel slab. The amount of MEK until saturation is 301 g/m³×27 m³=8.1 kg. The MEK loss distributed across all gel slabs is 8.1 kg/100 slabs=81 g/slab which is significantly lower than the 350 g limit. Thus, there is no negative impact on quality. As there is no MEK emission outside of the inert room or area, there is no environmental impact.

### Example 6

An inert room or area of 5×5×5 m³ with pre-saturated atmosphere for 100 slabs was analyzed. In a pre-saturated inert atmosphere, there is no explosion hazard. Further, in a pre-saturated inert atmosphere, there is no health hazard as human beings are not exposed to this atmosphere. Still further, in a pre-saturated inert atmosphere, there no evaporation from slabs such that there is no impact on quality. As there is no MEK emission outside of the inert room or area, there is no environmental impact.

Table 2 gives a summary of the results for buffering during demolding according to the above examples 1 to 6. The respective examples 1 to 6 are indicated in the second to seventh columns from the left in this order and the respective analyzed aspects of explosion hazard, health hazard, quality impact and environmental hazard are given in the second to fifth lines from the top in this order.

TABLE 2

| | Exam- | Exam- | Exam- | Exam- | Exam- | Exam- |
|---|---|---|---|---|---|---|
| | ple 1 | ple 2 | ple 3 | ple 4 | ple 5 | ple 6 |
| Explosion | Yes | No | No | No | No | No |
| hazard | | | | | | |
| Health hazard | Yes | No | Yes | No | No | No |
| Quality impact | Yes | No | Yes | Yes | No | No |
| Environmental | (Yes)* | (No)* | (Yes)* | (No)* | (No)* | (No)* |
| hazard* | | | | | | |

*Can be mitigated by off-gas treatment

Table 3 gives an overview of variations for the process steps of the disclosed method. In table 3, the respective process steps, filling buffering 1, demolding, buffering 2 and drying are indicated in the second to sixth columns in this order. Buffering 1 indicates a step of buffering carried out between filling of the precursors into the mold or lower part thereof, respectively, and demolding. Further, buffering 2 indicates a step of buffering between demolding and drying. The respective examples 1 to 6 are given in the second to seventh lines from the top in this order. The index “x” indicates the feasibility of a respective method step.

TABLE 3

| | Filling | Buffering 1 | Demolding | Buffering 2 | Drying |
|---|---|---|---|---|---|
| Example 1 | | | | | |
| Example 2 | | x | | | |
| Example 3 | x | | (x)* | | |
| Example 4 | x | x | (x)* | | |
| Example 5 | x** | x** | x** | x** | x** |
| Example 6 | x | x | x | x | x |

*Possible if residence time per slab is low enough to prevent explosion, health hazard and quality impact due to premature solvent evaporation
**Possible if solvent evaporation per slab does not exceed maximum for negative impact on quality

From table 3, it can be taken which of the disclosed method steps are feasible under which circumstances or conditions.

### CITED LITERATURE

WO 00/24799

1. A method for manufacturing a body made of a porous material derived from precursors of the porous material in a sol-gel process, the method comprising:
(i) providing a mold, wherein the mold comprises
a lower part defining an interior volume for receiving the precursors of the porous material, wherein the interior volume defines a shape of the body, and at least a first opening through which the body is removed from the lower part,
wherein surfaces of the lower part facing the interior volume are at least partially provided with a coating made of a material being electrically dissipative and non-sticky to the precursors of the porous material and/or the body,
(ii) filling precursors of the porous material into the lower part in a first inert or ventilated region, wherein the precursors comprise two reactive components and a solvent,
(iii) removing the body from the lower part through the first opening after a predetermined time in which the body is formed from the precursors of the porous material,
(iv) disposing the body onto a support, and
(v) removing the solvent from the body.

2. The method according to claim 1, wherein the mold further comprises a cover part configured to close the first opening, a second opening, and a lid configured to close the second opening, wherein the method further comprises closing the first opening by means of the cover part, filling precursors of the porous material into the lower part through the second opening, and closing the second opening by means of the lid.

3. The method according to claim 2, further comprising closing the first opening and/or the second opening in a gas tight manner.

4. The method according to claim 2, further comprising removing the cover part from the lower part in a second inert or ventilated region after a predetermined time in which the body is formed from the precursors of the porous material.

5. The method according to claim 1, wherein the removing the body from the lower part and the disposing the body onto the support comprise disposing the support onto the lower part and turning the lower part together with the support.

6. The method according to claim 5, further comprising fixing the support onto the lower part.

7. The method according to claim 1, wherein the support comprises openings.

8. The method according to claim 1, further comprising buffering the body in a third inert region before removing the solvent from the body.

9. The method according to claim 1, further comprising buffering a plurality of bodies in a third inert region and subsequently simultaneously removing the solvent from the plurality of bodies.

10. The method according to claim 4, further comprising repeating steps (i) to (iv) a predetermined number of times in a subsequent order so as to provide the plurality of bodies.

11. The method according to claim 9, wherein a volume of the third inert region is adapted to a total volume of the plurality of bodies and/or the third inert region is filled or pre-saturated with vapor of the solvent such that a substantial shrinking of the gel is prevented.

12. The method according to claim 9, further comprising sealing the first inert or ventilated region, a second inert or ventilated region and/or the third inert region in a gas tight manner.

13. The method according to claim 1, wherein the first inert or ventilated region and/or a second inert or ventilated region are defined by a chamber.

14. The method according to claim 13, wherein the first inert or ventilated region is a ventilated region and/or the second inert or ventilated region is a ventilated region, wherein the chamber comprises an airlock.

15. The method according to claim 1, wherein removing the solvent from the body is performed by means of an autoclave or oven.
